(19) United States
(12) Patent Application Publication
(10) Pub. No.: US 2013/0307759 A1
(43) Pub. Date: Nov. 21, 2013

(54) ORGANIC LIGHT EMITTING DIODE DISPLAY

(71) Applicant: SAMSUNG DISPLAY CO., LTD., Yongin-City (KR)

(72) Inventor: Yong-Kyu Jang, Yongin-City (KR)

(73) Assignee: Samsung Display Co., Ltd., Yongin-City (KR)

(21) Appl. No.: 13/661,859

(22) Filed: Oct. 26, 2012

(30) Foreign Application Priority Data
May 18, 2012 (KR) 10-2012-0053104

(51) Int. Cl. G09G 3/30

(52) U.S. Cl. 345/76

(57) ABSTRACT

An OLED display that can suppress color characteristic variation according to an observation angle. An OLED display includes a display unit provided on a substrate having an organic light emitting element displaying an image and a color compensation filter provided on a light emission side of the display unit. The color compensation filter includes a transparent base and a plurality of dichroic dyes arranged along an optical axis that is parallel with a line normal to the substrate in the base.

### CROSS-REFERENCE TO RELATED APPLICATION

This application claims priority to and the benefit of Korean Patent Application No. 10-2012-0053104 filed in the Korean Intellectual Property Office on May 18, 2012, the entire contents of which are incorporated herein by reference.

### BACKGROUND OF THE INVENTION

1. Field of the Invention

The present invention relates to an organic light emitting diode (OLED) display. More particularly, the present invention relates to an OLED display that can suppress color characteristic variations according to observation angle.

2. Description of the Related Art

Unlike the liquid crystal display (LCD), an organic light emitting diode (OLED) display does not require a separate light source, thereby making it possible to be implemented as a slim and lightweight display. Furthermore, the OLED display has high quality characteristics, such as lower power consumption, high luminance, and short response time.

The OLED display includes an organic light emitting element where a first electrode, an organic emission layer, and a second electrode are layered. One of the first and second electrodes is a reflective electrode and the other is a transmissive electrode such that light from the organic emission layer that propagates in a direction of the transmissive electrode and is emitted. In this case, the transmissive electrode is a layered structure of a transparent conductive layer and a semi-transparent metal layer and resonates part of the light, thereby enhancing a color reproduction rate.

However, in an OLED display employing a resonance structure, an observation angle is increased in a horizontal direction such that color characteristics are changed. This is because a resonance condition of light is changed according to an observation angle. Accordingly, when white color is realized at the front of the OLED display, the white color is altered to a specific color when being observed at a location having a large observation angle. In other words, a color shift occurs.

The above information disclosed in this Background section is only for enhancement of understanding of the background of the invention and therefore it may contain information that does not constitute prior art under 35 U.S.C. 102.

### SUMMARY OF THE INVENTION

The present invention has been made in an effort to provide an organic light emitting diode (OLED) display that can suppress color characteristic variation according to an observation angle.

An OLED display according to an exemplary embodiment of the present invention includes an organic light emitting diode (OLED) display, including a display unit to display an image and including a substrate and an organic light emitting element and a color compensation filter arranged on a light emitting side of the display unit and including a transparent base and a plurality of dichroic dyes arranged along an optical axis that is parallel with a line perpendicular to the substrate. The plurality of dichroic dyes may be arranged along a thickness direction of the base. The dichroic dyes may be vertically aligned. The OLED display may also include a polarization member arranged on one side of the color compensation filter and including a linear polarization layer and a ¼ wavelength layer. The color compensation filter may also include an alignment layer arranged on one side of the base and a reactive mesogen arranged within the base. The reactive mesogen may be arranged in a same direction as the dichroic dyes.

The alignment layer may contact the ¼ wavelength layer. The optical axis direction color of the color compensation filter may be an achromatic color, and a transmissive color of the color compensation filter, observed in a direction having a predetermined tilt angle with respect to the optical axis and a color of light emitted in the same direction to the predetermined tilt angle in the display unit have a complementary color relationship. The color compensation filter may absorb light of blue color in a direction having a predetermined tilt angle with respect to the optical axis.

The display may also include a sealing substrate arranged between the color compensation filter and the display unit and including one of a glass substrate and an organic layer and an inorganic layer alternately arranged. The polarization member may be used as a substrate for the color compensation filter, and the alignment layer may include polyimide and be coated on the polarization member, is rubbed, and then cured. The base including the reactive mesogen and the dichroic dyes are coated on the alignment layer and then the base is cured. The color compensation filter may transmit light propagating along the optical axis normal to a front surface of the display without changing color while converting blue light propagating in a side direction into white light for viewing by a viewer at a predetermined tilt angle with respect to the optical axis.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a partial cross-sectional view of an organic light emitting diode display according to a first exemplary embodiment of the present invention;

FIG. 2 shows a circuit alignment of a display panel of FIG. 1;

FIG. 3 is a partial cross-sectional view for description of operation of the organic light emitting diode display of FIG. 1;

FIG. 4 is a partial cross-sectional view of an organic light emitting diode display according to a second exemplary embodiment of the present invention;

FIG. 5 is a partial cross-sectional view of an organic light emitting diode display according to a third exemplary embodiment of the present invention; and

FIG. 6 is a partial cross-sectional view of an organic light emitting diode display according to a fourth exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

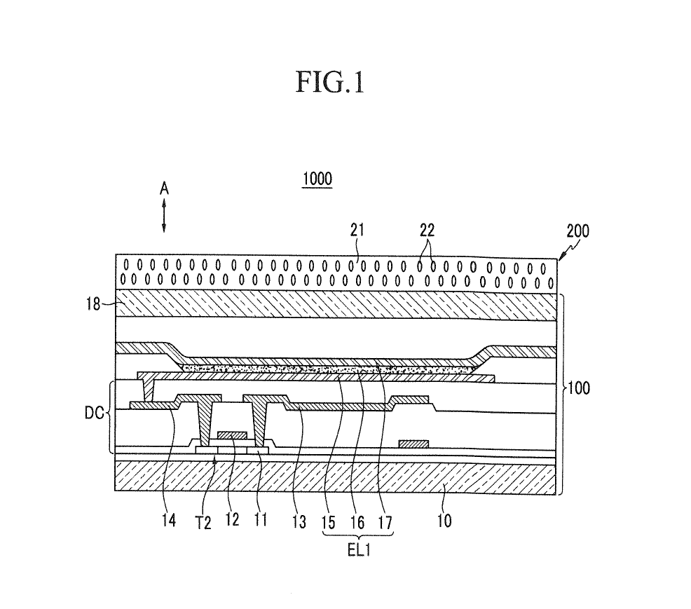

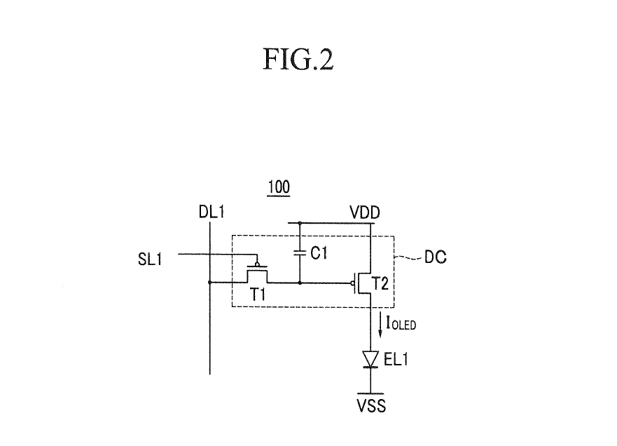

Turning now to FIGS. 1 and 2, FIG. 1 is a partial cross-sectional view of an organic light emitting diode (OLED) display according to a first exemplary embodiment of the present invention and FIG. 2 shows a circuit alignment of a display panel shown in FIG. 1.

Referring now to FIG. 1, an OLED display 1000 according to the first exemplary embodiment includes a display unit 100 and a color compensation filter 200. The display unit 100 includes a substrate 10, an organic light emitting element EL1, and a driving circuit DC, and displays a predetermined image using light emitted from the organic light emitting element EL1. The color compensation filter 200 is disposed at a light emission side of the display unit 100, and suppresses color variation of the display unit 100 according to an observation angle by including a plurality of dichroic dyes 22 arranged in one direction.

The substrate 10 may be made out of one of an inorganic material such as glass, a metal material, and an organic material such as a resin, and may be flexible. A scan line SL1, a data line DL1, a driving power line VDD, and a common power line VSS shown in FIG. 2 are formed on the substrate 10, and the lines are connected to the driving circuit DC.

FIG. 1 illustrates only a driving thin film transistor T2 in the driving circuit DC for better understanding and ease of description.

Referring to FIG. 2, the driving circuit DC includes two or more thin film transistors T1 and T2 and at least one storage capacitor C1. The thin film transistors basically include a switching thin film transistor T1 and a driving thin film transistor T2.

The switching thin film transistor T1 is connected to the scan line SL1 and the data line DL1, and transmits a data voltage input to the data line DL1 to the driving thin film transistor T2 according to a switching voltage input to the scan line SL1. The storage capacitor C1 is connected to the switching thin film transistor T1 and the driving power line VDD, and stores a voltage corresponding to a voltage difference between a voltage transmitted by the switching thin film transistor T1 and a voltage supplied to the driving power line VDD.

The driving thin film transistor T2 is connected to the driving power line VDD and the storage capacitor C1 to supply an output current I_{OLED} to the organic light emitting element LE1 whose magnitude is proportional to a square of a difference between the voltage stored in the storage capacitor C1 and a threshold voltage of transistor T2. FIG. 2 illustrates an active matrix type of organic light emitting diode display having a 2Tr-1Cap structure in which one sub-pixel includes two thin film transistors and one capacitor, however the present invention is not limited to this structure.

Referring back to FIG. 1, the driving thin film transistor T2 includes an active layer 11, a gate electrode 12, a source electrode 13, and a drain electrode 14. The organic light emitting element EL1 includes a first electrode 15, an organic emission layer 16, and a second electrode 17 that are sequentially layered. The first electrode 15 is individually formed in each pixel, and the second electrode 17 is commonly formed through all the pixels. One of the first electrode 15 and the second electrode 17 functions as an anode that injects holes into the organic emission layer 16, and the other functions as a cathode that injects electrons into the organic emission layer 16.

The first electrode 15 is connected to the drain electrode 14 of the driving thin film transistor T2, and the second electrode 17 is connected with the common power line VSS. One of the first electrode 15 and the second electrode 17 is a reflective electrode and the other is a transmissive electrode. Thus, light emitted from the organic emission layer 16 that propagates toward the transmissive electrode may then emitted to the outside of the display unit 100.

In FIG. 1, the first electrode 15 is a reflective electrode and the second electrode 17 is a transmissive electrode, so that light produced by the organic emission layer 16 is emitted towards the second electrode 17. Alternatively, the first electrode 15 may be a transmissive electrode and the second electrode 17 may be a reflective electrode such that light produced by the organic emission layer 16 may be emitted to a direction of the first electrode 15. In this alternative case, the color compensation filter 200 is disposed under the display unit 100 in the drawing.

The transmissive electrode has a layered-structure of a transparent conductive layer and a semitransparent metal layer such that light is partially reflected. The light reflected from the transmissive electrode is reflected again by the reflective electrode and thus resonated. The organic light emitting element EL1 can enhance a color reproduction rate by employing such a resonance structure.

The display unit 100 includes a sealing substrate 18 sealing the organic light emitting element EL1. The sealing substrate 18 may be a glass substrate fixed on the substrate 10 by a sealant, or may be a thin film encapsulation layer. The thin film encapsulation layer has a structure in which an organic layer and an inorganic layer are alternately layered. FIG. 1 exemplarily illustrates that the sealing substrate 18 is disposed above the organic light emitting element EL1.

The configurations of the driving circuit DC and the organic light emitting element EL1 are not limited to the above-described exemplary embodiment, and may be variously modified in various known configurations that can easily be implemented by those skilled in the art.

The color compensation filter 200 includes a base 21 and a plurality of dichroic dyes 22 arranged in one direction in the base 21. The base 21 is extended in a thickness direction and thus the dichroic dyes 22 are arranged along the thickness direction of the base 21. An optical axis of the dichroic dyes 22 matches the arrangement direction (i.e. the thickness direction of the base 21) of the dichroic dyes 22.

An average optical axis of the dichroic dyes 22 substantially matches a line normal (i.e., the direction of arrow A in FIG. 1) to the substrate 10 in the display unit 100. In this case, the substantial match implies that the average optical axis of the dichroic dyes 22 may deviate slightly within an allowable deviation range with respect to the normal line due to an error occurring during a manufacturing process.

A light absorption characteristic according to the optical axis direction and a light absorption characteristic according to a direction that is perpendicular to the optical axis are different from each other. Accordingly, a color viewed from the front of the color compensation filter 200 (i.e., a color according to the optical axis direction) and a color viewed from the side of the color compensation filter 200 (i.e., a color viewed in case of observation with a predetermined tilt angle with respect to the optical axis) have different characteristics.

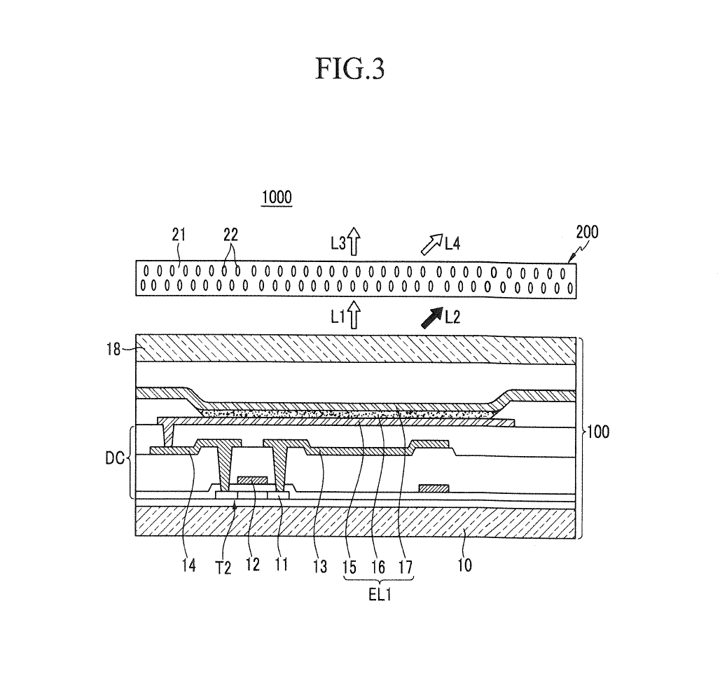

Turning now to FIG. 3, FIG. 3 is a partial cross-sectional view for describing operation of the OLED display of FIG. 1. Referring now to FIG. 3, the color compensation filter 200 minimizes color variation for light L1 (with observation angle of 0°) emitted to the front from the display unit 100, and absorbs much more light of a particular color for light L2 (for convenience, referred to as light emitted toward a side direction) emitted with a predetermined tilt angle with respect to the normal line from the display unit 100.

That is, a color of an optical axis direction of the color compensation filter 200 represents an achromatic color or a white color. In addition, a transmittance color L4 of the color compensation filter 200, observed in a direction having a predetermined tilt angle with respect to the optical axis, and a color of the light L2 emitted to the side direction from the display unit 100, have a complementary color relationship.

For example, when light L1 emitted to the front from the display unit 100 is a light of a white color, light L3 that passes through the color compensation filter 200 may be the same as the light L1 of the white color or represents a white color of which color variation is minimized. In addition, when the light L2 emitted in the side direction from the display unit 100 represents a washy blue color, the color compensation filter 200 has a transmissive characteristic of a yellow color that absorbs a blue color. Accordingly, the color compensation filter 200 absorbs the blue color component of the light L2 emitted in the side direction from the display unit 100 and then transmits light L4 as a white color.

A color of the light L2 emitted to the side direction from the display unit 100 is related to a thickness of the organic emission layer 16. The thickness of the organic emission layer 16 is different in a red color pixel, a green color pixel, and a blue color pixel, and the light L2 emitted in a side direction from the display unit 100 may express other colors than a blue color. In all the cases, a transmittance color of the color compensation filter 200, observed in a direction having a predetermined tilt angle with respect to the optical axis satisfies a complementary color relationship with a color of the light L2 emitted in the side direction from the display unit 100.

As described, the OLED display 1000 according to the present exemplary embodiment can enhance a color reproduction rate by employing a resonance structure, and at the same time can minimize color characteristic variation according to an observation angle by disposing the color compensation filter 200 at a light emission side of the display unit 100.

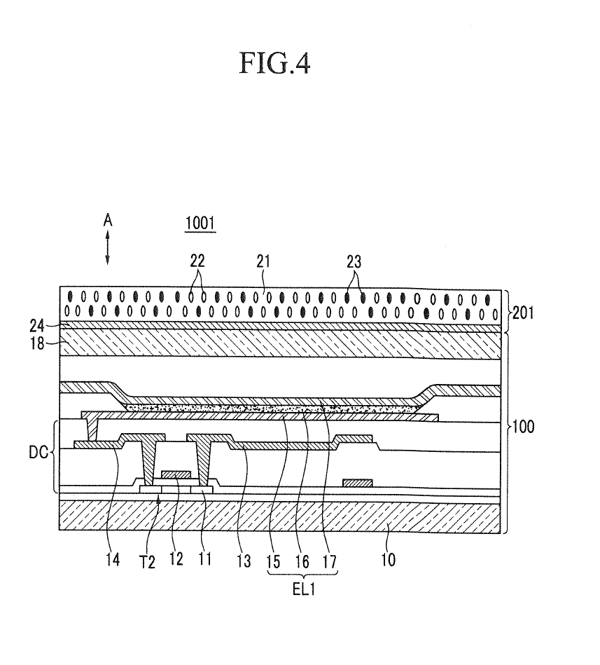

Turning now to FIG. 4, FIG. 4 is a partial cross-sectional view of an OLED display 1001 according to a second exemplary embodiment of the present invention. Referring now to FIG. 4, the OLED display 1001 of the second exemplary embodiment has the same configuration of the OLED display of the first exemplary embodiment, except that a reactive mesogen 23 and an alignment layer 24 are additionally included in a color compensation filter 201. The same reference numerals refer to the same members as in the first exemplary embodiment.

The color compensation filter 201 includes a transparent base 21, a plurality of dichroic dyes 22 and a plurality of reactive mesogens 23 arranged in one direction in the base 21, and an alignment layer 24 disposed at one side of the base 21. FIG. 4 exemplarily illustrates that the alignment layer 24 is disposed on a side of the base 21 that faces the display unit 100, but the location of the alignment layer 24 is not limited thereto.

The surface of the alignment layer 24 has a specific shape due to a rubbing process, and therefore materials contacting the alignment layer 24 are aligned to a specific direction. The reactive mesogen 23 is one of a photopolymerizable monomer or oligomer and cured by ultraviolet UV, and, like crystal liquid, the reactive mesogen 23 is aligned according to a characteristics of the alignment layer 24. The dichroic dyes 22 are aligned in the same direction as the reactive mesogens 23.

In the color compensation filter 201 of the second exemplary embodiment, the alignment layer 24 is a vertical alignment layer, and aligns the reactive mesogen 23 and the dichroic dyes 22 parallel to each other along a direction parallel to a normal direction (i.e., direction of the arrow A in the drawing) of the display unit 100. Operation of the color compensation filter 201 is the same as that of the first exemplary embodiment, and therefore no further description will be provided.

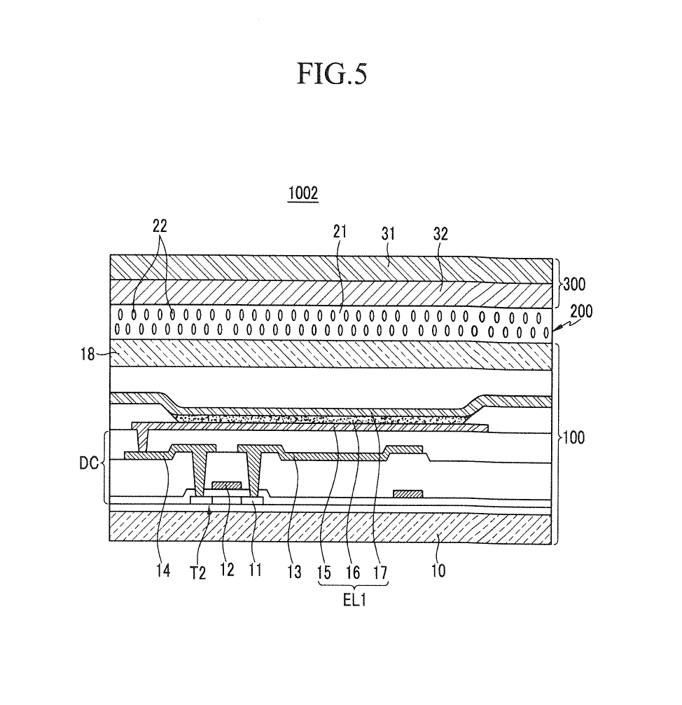

Turning now to FIG. 5, FIG. 5 is a partial cross-sectional view of an OLED display according to a third exemplary embodiment of the present invention. Referring to FIG. 5, an OLED display 1002 according to the third exemplary embodiment has the same configuration of the OLED display of the first exemplary embodiment, except that OLED display 1002 further includes a polarization member 300 having a linear polarization layer 31 and a ¼ wavelength layer 32. The same reference numerals refer to the same members as in the first exemplary embodiment.

The polarization member 300 may be provided in a light emission side of a color compensation filter 200, or may be provided between the color compensation filter 200 and a display unit 100, however FIG. 5 illustrates the example where the polarization member 300 is provided at the light emission side of the color compensation filter 200.

Among external light entering to the OLED 1002, a component vibrating in a direction parallel to an absorption axis of the linear polarization layer 31 is absorbed and a component vibrating in a direction parallel with a transmissive axis is transmitted. The transmitted component is converted into a circularly polarized light rotating in one direction while passing through the ¼ wavelength layer 32 and is then reflected by a first electrode 15 of the organic light emitting element EL1.

The light reflected by the first electrode 15 becomes a circularly polarized light rotating in the opposite direction, and is then converted into a linearly polarized light in a direction that is perpendicular to a transmissive axis of the linear polarization layer 31 while passing through the ¼ wavelength layer 32. The linearly polarized light cannot be emitted to the outside of the polarization member 300 because the light is absorbed by the transmissive axis of the linear polarization layer 31, and thus this reflected external light is absorbed by the linear polarization layer 31, thereby reducing glare.

Accordingly, the OLED display 1002 provided with the polarization member 300 minimizes reflection of external light so that contrast can be improved and outside visibility can be improved. Operation of the color compensation filter 200 is the same as that of the first exemplary embodiment, and therefore no further description will be provided.

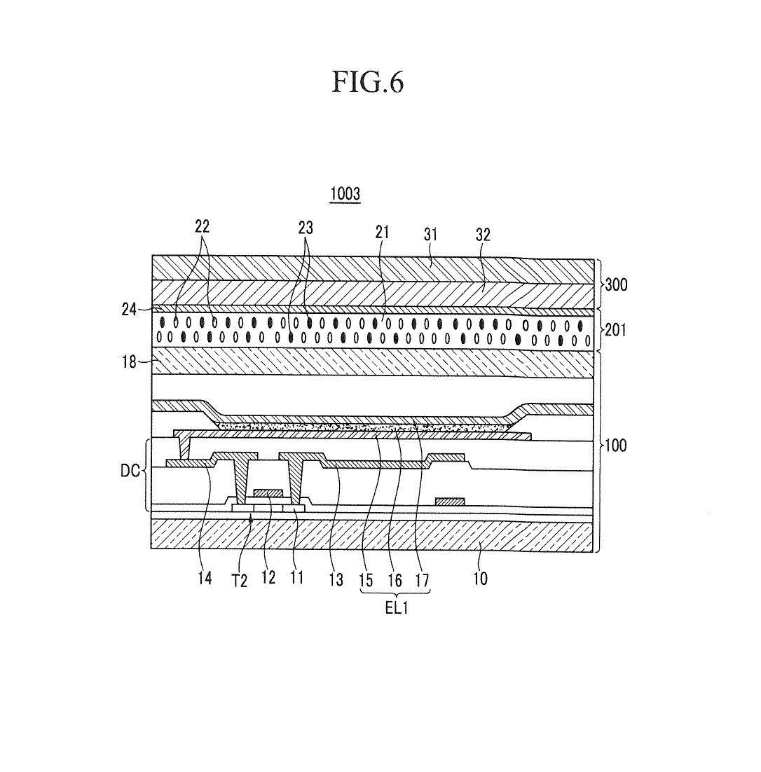

Turning now to FIG. 6, FIG. 6 is a partial cross-sectional view of an OLED display 1003 according to a fourth exemplary embodiment of the present invention. Referring to FIG. 6, the OLED display 1003 according to the fourth exemplary embodiment has the same configuration of the OLED display of the second exemplary embodiment, except that a polarization member 30 having a linear polarization layer 31 and a ¼ wavelength layer 32 is additionally included as in the third embodiment. The same reference numerals refer to the same members as in the second and third exemplary embodiment.

The polarization member 300 may be provided in a light emission side of a color compensation filter 201, or may be provided between the color compensation filter 201 and a display unit 100, however FIG. 6 illustrates the scenario where the polarization member 300 is provided on the light emission side of the color compensation filter 201.

In the fourth exemplary embodiment, the polarization member 300 may be used as a substrate for the color compensation filter 201. That is, an alignment material (e.g., polyimide) is coated on the polarization member 300, rubbed, and then cured such that an alignment layer 24 is formed, and a base 21 including a reactive mesogen 23 and a dichroic dye 22 is coated on the alignment layer material (e.g., polyimide) and then the base 21 is cured by ultraviolet (UV) radiation so that the color compensation filter 201 can be manufactured. In FIG. 6, the alignment layer 24 of the color compensation filter 201 contacts a ¼ wavelength layer 32 of the polarization member 300.

When the polarization member 300 is used as a substrate of the color compensation filter 201, the color compensation filter 201 has a thickness as small as less than several micrometers (μm), and accordingly the thickness of the OLED display 1003 is not substantially influenced. A function of the polarization member 300 that minimizes reflection of external light is the same as that of the third exemplary embodiment, and accordingly no further description will be provided.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

1000, 1001, 1002, 1003: organic light emitting diode (OLED) display

| | |
|---|---|
| 100: display unit | 10: substrate |
| 11: active layer | 12: gate electrode |
| 13: source electrode | 14: drain electrode |
| 15: first electrode | 16: organic emission layer |
| 17: second electrode | 200, 201: color compensation filter |
| 21: base | 22: dichroic dye |
| 23: reactive mesogens | 24: alignment layer |
| 300: polarization member | 31: linear polarization layer |
| 32: ¼ wavelength layer | 18: sealing substrate |
| DC: driving circuit | A: tangent line of display |
| EL1: organic light emitting layer | T1: switching transistor |
| T2: driving transistor | DL1: data line |
| SL1: scan line | C1: storage capacitor |
| VSS: common power line | VDD: driving power line |

What is claimed is:

1. An organic light emitting diode (OLED) display, comprising:
a display unit to display an image and including a substrate and an organic light emitting element; and
a color compensation filter arranged on a light emitting side of the display unit and including a transparent base and a plurality of dichroic dyes arranged along an optical axis that is parallel with a line perpendicular to the substrate.

2. The OLED display of claim 1, wherein the plurality of dichroic dyes are arranged along a thickness direction of the base.

3. The OLED display of claim 2, further comprising a polarization member arranged on one side of the color compensation filter and comprising a linear polarization layer and a ¼ wavelength layer.

4. The OLED display of claim 1, wherein the color compensation filter further comprises:
an alignment layer arranged on one side of the base; and
a reactive mesogen arranged within the base.

5. The OLED display of claim 4, wherein the reactive mesogen is arranged in a same direction as the dichroic dyes.

6. The OLED display of claim 4, further comprising a polarization member provided on one side of the color compensation filter and comprised a linear polarization layer and a ¼ wavelength layer.

7. The OLED display of claim 6, wherein the alignment layer contacts the ¼ wavelength layer.

8. The OLED display of claim 1, wherein an optical axis direction color of the color compensation filter is an achromatic color, and a transmissive color of the color compensation filter, observed in a direction having a predetermined tilt angle with respect to the optical axis and a color of light emitted in the same direction to the predetermined tilt angle in the display unit have a complementary color relationship.

9. The OLED display of claim 4, wherein an optical axis direction color of the color compensation filter is an achromatic color, and a transmissive color of the color compensation filter, observed in a direction having a predetermined tilt angle with respect to the optical axis and a color of light emitted in the same direction to the predetermined tilt angle in the display unit have a complementary color relationship.

10. The OLED display of claim 6, wherein an optical axis direction color of the color compensation filter is an achromatic color, and a transmissive color of the color compensation filter, observed in a direction having a predetermined tilt angle with respect to the optical axis and a color of light emitted in the same direction to the predetermined tilt angle in the display unit have a complementary color relationship.

11. The OLED display of claim 8, wherein the color compensation filter absorbs a light of blue color in a direction having the predetermined tilt angle with respect to the optical axis.

12. The OLED display of claim 6, wherein the polarization member is used as a substrate for the color compensation filter, and the alignment layer comprised of polyimide is coated on the polarization member, is rubbed, and then cured.

13. The OLED display of claim 12, wherein the base including the reactive mesogen and the dichroic dyes are coated on the alignment layer and then the base is cured.

14. The OLED display of claim 1, the color compensation filter to transmit light propagating along the optical axis normal to a front surface of the display without changing color while converting blue light propagating in a side direction into white light for viewing by a viewer at a predetermined tilt angle with respect to the optical axis.

15. The OLED display of claim 1, the organic light emitting element comprising a resonant structure that includes an organic emission layer arranged between a first electrode and a second electrode, the first electrode being reflective and the second electrode being transmissive and including a semi-transparent conductive layer arranged on a transparent conductive layer to reflect a portion and transmit a remaining portion of light resonating between the first and second electrodes.

16. The OLED display of claim 6, the organic light emitting element comprising a resonant structure that includes an organic emission layer arranged between a first electrode and a second electrode, the first electrode being reflective and the second electrode being transmissive and including a semi-transparent conductive layer arranged on a transparent conductive layer to reflect a portion and transmit a remaining portion of light resonating between the first and second electrodes.
